(19) United States
(12) Patent Application Publication
(10) Pub. No.: US 2026/0111844 A1
(43) Pub. Date: Apr. 23, 2026

(54) SYSTEM

(71) Applicant: SOFTBANK GROUP CORP., Minato-ku, Tokyo (JP)

(72) Inventor: Junya NOSE, Minato-ku, Tokyo (JP)

(73) Assignee: SOFTBANK GROUP CORP., Minato-ku, Tokyo (JP)

(21) Appl. No.: 19/357,199

(22) Filed: Oct. 14, 2025

(30) Foreign Application Priority Data
Oct. 17, 2024 (JP) 2024-181631

(51) Int. Cl. G06Q 10/10; G06Q 10/0633

(52) U.S. Cl. CPC G06Q 10/10; G06Q 10/0633

(57) ABSTRACT

A system includes a processor that is configured to collect a sequence of operations performed on a user computer device, analyze the collected operation data and identify repetitive operations, generate automation proposals for the identified repetitive tasks, train and construct a domain-specific generation model using the operation data, present the automation proposals to the user and execute the automation upon user approval.

### CROSS-REFERENCE TO RELATED APPLICATION

This application is based on and claims priority under 35 USC 119 from Japanese Patent Application No. 2024-181631 filed on October 17, 2024, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In recent years, users have been required to perform numerous repetitive operations on their computer devices as part of their daily tasks. These manual and often redundant tasks not only decrease work efficiency but also increase the possibility of human error. Furthermore, conventional automation approaches often require specialized technical knowledge or extensive configuration, which can be a barrier for general users. There is also the additional challenge of adapting automation systems to user-specific or domain-specific work without compromising data security or privacy.

### SUMMARY

In order to solve the foregoing problems, the invention provides a system including a processor configured to collect a sequence of operations performed on a user's computer device, analyze the collected operation data to identify repetitive tasks, and generate automation proposals for such repetitive tasks. The processor further trains and constructs a domain-specific generation model using operation data to improve the relevance and effectiveness of automation suggestions. The system presents automation proposals to the user and executes automation upon user approval. Additionally, the processor is configured to update the generation model based on user feedback and to transmit operation data in an encrypted manner to address security and privacy concerns.

“processor” means a hardware component or set of components capable of executing instructions, performing operations, and controlling the overall functioning of the system.

“operation data” means information representing a sequence of user actions or events performed on a computer device, including but not limited to application usage, file handling, window switching, and input activities.

“repetitive operations” means user actions or tasks that occur with similar patterns or frequencies over time on a computer device, indicating routine or redundant tasks.

“automation proposal” means a suggestion or recommendation generated by the system for automating identified repetitive tasks, which may include concrete steps or scripts to be executed automatically.

“generation model” means a machine-learning-based or algorithmic model trained with operation data to tailor automation proposals to specific user workflows or business domains.

“user approval” means the explicit agreement or confirmation provided by the user to authorize the system to execute one or more automation proposals.

“user feedback” means input or evaluation provided by the user regarding the accuracy, effectiveness, or usefulness of the automation proposals or executed automations.

“encrypted manner” means the method of transmitting data in a form that is unreadable to unauthorized parties, typically by applying a cryptographic algorithm to protect the confidentiality and integrity of the data.

“domain-specific” means tailored or customized to the particular requirements, characteristics, or context of a specific field of work, industry, or business operation.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

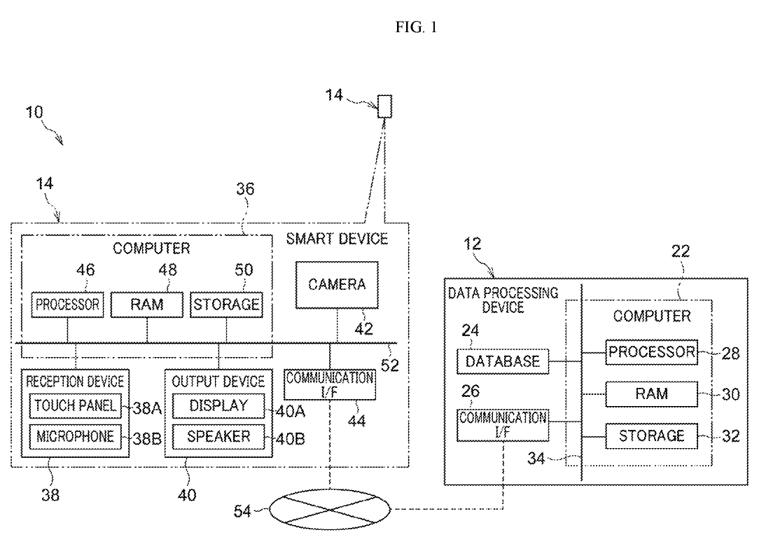

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

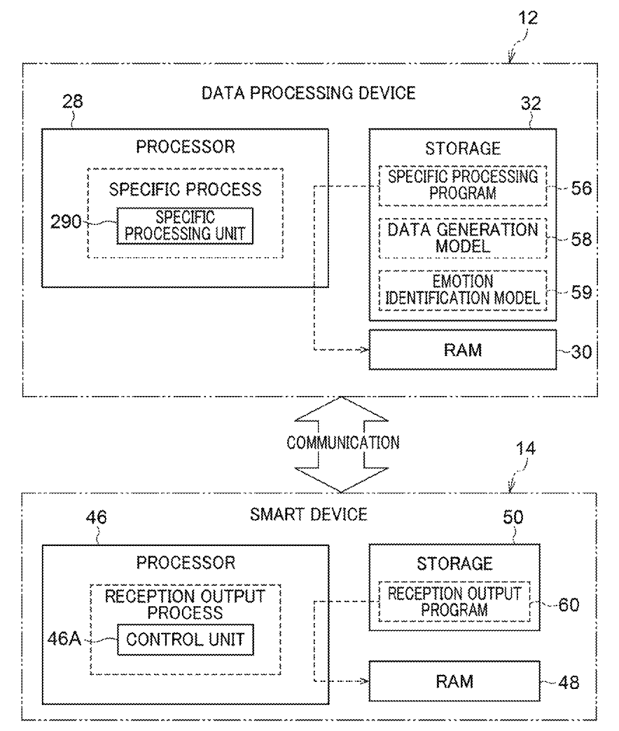

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In various fields, repetitive and time-consuming operations performed by users on information processing devices often hinder overall work efficiency. Conventional automation solutions require manual setup and lack adaptability to user-specific workflows or business needs. Furthermore, transmitting sensitive user operation data for analysis raises security and privacy concerns. There is therefore a need for a system that can automatically and securely acquire user operation data, identify repetitive patterns, and generate appropriate automation proposals tailored to business processes while protecting user data during transmission and handling.

The specific processing by the specific processing unit 290 of the data processing device 12 in Example 1 is realized by the following means.

The present invention provides a server comprising a processor configured to acquire operation history information from a user's information processing device, encrypt and receive the operation data over a secure communication path, analyze the decrypted information using machine learning and pattern recognition techniques to identify repetitive operation patterns, generate automation proposals by utilizing a generative artificial intelligence model with prompts reflecting business-specific content, present the proposals to the user for approval or modification, execute approved automation on the information processing device, and retrain the generative artificial intelligence model based on received feedback. This enables automated and efficient optimization of user workflows in a secure manner, ensuring that automation proposals are adapted to each user's routine operations and business requirements while maintaining data security.

The term “operation history information” refers to data representing a chronological record of actions performed by a user on an information processing device, including but not limited to application launches, file operations, keystrokes, and window switches.

The term “information processing device” refers to an electronic apparatus capable of executing computational processes and software applications, such as a personal computer, smartphone, or tablet.

The term “data processing device” refers to a computing apparatus, typically a server, that receives, stores, analyzes, and processes data received from one or more information processing devices.

The term “communication path” refers to a channel or network infrastructure that enables the transmission of data between devices, such as the Internet, a local area network, or a secure virtual private network.

The term “machine learning technique” refers to a computational method that enables a device to identify patterns or make decisions based on large volumes of data using algorithms that learn and adapt from the data.

The term “pattern recognition technique” refers to a computational process that identifies recurring sequences or structures within datasets, often using statistical, algorithmic, or heuristic approaches.

The term “repetitive operation pattern” refers to a sequence of actions automatically identified as recurring within a user’s operation history over a period of time.

The term “generative artificial intelligence model” refers to a machine learning model that produces text, proposals, or other content in response to natural language prompts, and is capable of adapting outputs based on specific input data or business requirements.

The term “prompt sentence” refers to a text input, typically formulated in natural language, which is supplied to the generative artificial intelligence model to direct the content or focus of the generated output.

The term “automation proposal information” refers to a set of suggestions or instructions generated based on identified repetitive operation patterns, intended to automate or optimize certain business or user-specific processes.

The term “secure communication path” refers to a communication channel that provides encryption and authentication to protect data transmitted between devices against unauthorized access or interception.

The term “feedback information” refers to responses, evaluations, or data provided by a user or device that reflect the effectiveness or accuracy of proposed or executed automation processes, used for system optimization and retraining of models.

The present invention may be implemented by constructing a system comprising a server (data processing device) and a plurality of terminals (information processing devices) operated by users. The terminal can be a personal computer, laptop, tablet, or smartphone running any general-purpose operating system, including Windows, macOS, Linux, iOS, or Android. The server can be a general-purpose server or a cloud-based computing instance capable of running server-side applications and machine learning frameworks such as TensorFlow or PyTorch.

The embodiment entails installing a monitoring agent program on each terminal. This agent operates in the background and systematically collects operation history information by detecting user actions such as application launches, file operations, window switches, menu selections, and text input events. The collected data is stored temporarily in a local encrypted file. The encryption of operation history information is performed with standard encryption libraries, such as AES-256 (Advanced Encryption Standard), using OpenSSL or native cryptographic APIs provided by the operating system.

The terminal establishes a secure communication path with the server using a protocol such as HTTPS (Hypertext Transfer Protocol Secure), which employs TLS/SSL encryption, and periodically transmits the encrypted operation history information to the server. The server, upon receiving the encrypted data, decrypts it with the corresponding key and stores the information in a secure storage location.

The server executes data processing procedures using Python scripts or equivalent software, which employ machine learning techniques (e.g., using scikit-learn or TensorFlow) and pattern recognition algorithms to analyze the operation history information. The server identifies repetitive operation patterns unique to each user or role within the organization. Based on these patterns, the server constructs a prompt sentence tailored to the identified workflows and task context. The server then applies a generative AI model, such as a large language model (LLM) implemented via OpenAI API, Hugging Face Transformers, or an in-house trained model, by submitting the prompt sentence along with relevant context data. The generative AI model returns automation proposal information, which is structured and formatted into a recommendation message.

The server transmits the automation proposal information to the user’s terminal. The user, via a graphical user interface (such as a web dashboard created with React.js or a native GUI application), reviews the proposal, modifies details if necessary, and approves or rejects the automation process. If the user approves, the terminal downloads the specified automation script or configuration and executes the automation process, potentially using scripting frameworks such as Windows PowerShell, macOS Automator, or cron jobs on Linux.

Feedback regarding the effectiveness of the automation and any user modifications are gathered by the server and are used to retrain or fine-tune the generative AI model. Training and inference may be performed on the same server or on a dedicated machine learning infrastructure, utilizing data storage and management platforms as required.

For example, if a user regularly sends similar reports via email each week, the system can identify this repetitive behavior and generate a prompt like:

“Please propose a method to automate the weekly routine of sending emails to a customer list.”

The generative AI model may return actionable recommendations, such as scheduling automatic email dispatches or generating scripts to streamline the process. This workflow ensures that automation recommendations are customized, secure, and continuously improved in line with real user feedback and operational outcomes.

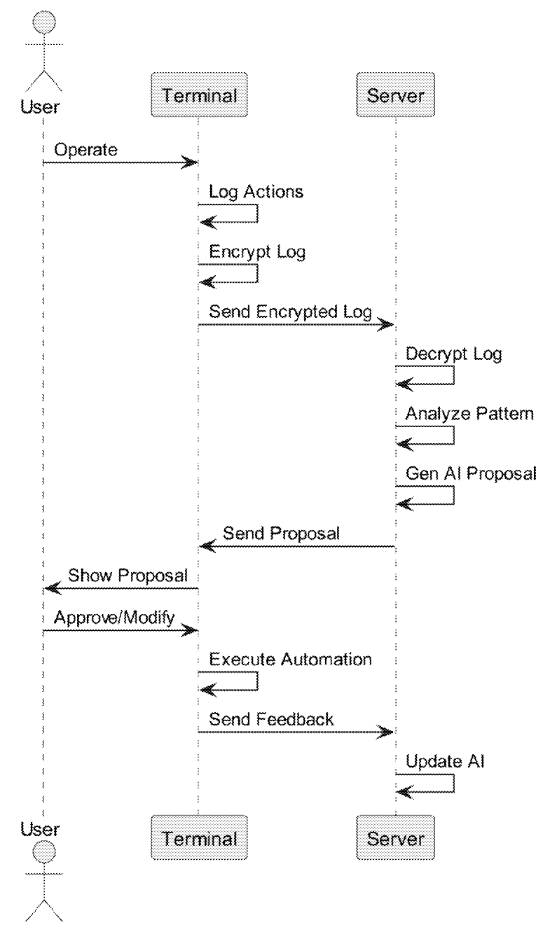

The following describes the processing flow using FIG. 11.

### Step 1:

The terminal collects operation history information from the user. The terminal runs a monitoring agent program that detects user actions such as application launches, file operations, and keystrokes. The input is real-time user interface events occurring on the terminal. The terminal processes these events by recording each operation along with a timestamp, application identifier, and relevant contextual data. The output is a structured operation log file temporarily stored on the terminal’s local storage.

### Step 2:

The terminal encrypts the collected operation log file. The terminal uses an encryption algorithm, such as AES-256, to convert the readable operation log file into an encrypted data file. The input is the previously stored operation log file. The terminal processes this data with cryptographic libraries to produce a secure and unreadable data file. The output is an encrypted operation log ready for transmission.

### Step 3:

The terminal transmits the encrypted operation log to the server using a secure communication path. The terminal establishes a secure HTTPS connection to the server and uploads the encrypted operation log at predefined intervals. The input is the encrypted operation log file, and the transmission process includes authentication of both the terminal and server. The output is delivery confirmation or receipt of the encrypted log by the server.

### Step 4:

The server receives and decrypts the encrypted operation log. The server stores the received encrypted log in a secured directory and applies decryption algorithms using the appropriate key to convert it back into a readable format. The input is the encrypted log file from the terminal. The server’s output is a decrypted operation log file ready for further analysis.

### Step 5:

The server analyzes the decrypted operation log to identify repetitive operation patterns. The server uses machine learning models and pattern recognition algorithms to examine the operation sequence and detect workflows that occur with significant frequency. The input is the decrypted operation log file. The server preprocesses the data, extracts feature vectors, trains or utilizes models, and outputs a list or set of identified repetitive operation patterns associated with the user.

### Step 6:

The server generates an automation proposal based on the identified repetitive patterns. The server constructs a prompt sentence describing the repetitive process and submits it to a generative AI model, which produces natural language suggestions or detailed action plans for automating the workflow. The input is the repetitive operation pattern list and associated business context. The output is the automation proposal information, typically formatted as readable text.

### Step 7:

The server transmits the automation proposal information to the terminal for user review. The server sends the automation suggestion to the user’s device, which displays the proposal via a graphical interface. The input is the automation proposal text; the output is the display of recommendations for user interaction.

### Step 8:

The user reviews, modifies if necessary, and approves or rejects the automation proposal. The user reads the proposed actions, makes changes to the plan if needed, and provides feedback or approval through the terminal’s interface. The input is the automation proposal as presented by the terminal. The output is the user's selection, which may be an approval, rejection, or a modified automation plan.

### Step 9:

The terminal executes the approved automation process. The terminal downloads or generates necessary automation scripts (such as shell scripts or macros) according to the user’s approval and schedules or runs the task as specified. The input is the approved automation plan created by the user. The terminal interprets and executes the prescribed operations, resulting in the output of completed automated tasks - such as sending emails, moving files, or updating documents independently.

### Step 10:

The server collects feedback and execution results from the terminal and user. The server receives logs indicating whether automation was successful, as well as any user critiques or suggestions. The input is execution logs and user feedback from the terminal. The server stores this information and processes it for continual learning. The output is updated training data, which the server uses to retrain or fine-tune the generative AI model, thereby improving future automation proposal accuracy and relevance.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In work environments where users repeatedly perform similar tasks, it is difficult to accurately identify repetitive operations and provide effective automation solutions that improve efficiency and reduce errors. Additionally, conventional systems do not take into account the emotional or physiological state of the user, resulting in automation proposals that may not address user burden or stress. There is also a need for a mechanism that ensures secure communication of sensitive user data and enables continuous learning and improvement of automation recommendations based on user feedback and biometric information.

The specific processing by the specific processing unit 290 of the data processing device 12 in Application Example 1 is realized by the following means.

The present invention provides a server comprising a processor configured to collect sequences of user operation information and biometric information, analyze these data sets for detection of repetitive actions, generate automation proposals using a generative artificial intelligence model trained on such information, and present these proposals to a user terminal for approval or modification. The processor is further configured to instruct external devices to execute business automation according to approved proposals, estimate user emotions and dynamically adjust output in response to user state, ensure the use of encrypted data communication, and update the generative artificial intelligence model using user feedback or biometric information. This enables highly accurate and personalized automation solutions to be presented and executed with consideration for user burden and wellbeing, while maintaining security and adaptability in industrial or business environments.

The term “user operation information” refers to data representing a sequence of actions, inputs, or commands performed by a user on an information processing device, such as keyboard inputs, mouse movements, application launches, or system interactions.

The term “biometric information” refers to data relating to the physiological or psychological state of a user, including but not limited to stress levels, emotional states, heart rate, gaze tracking, and behavioral patterns inferred from device interactions.

The term “information processing device” refers to an electronic device capable of processing, storing, and transmitting digital data in response to user operations, such as a computer, workstation, or smart device.

The term “data analysis techniques” refers to algorithms or computational procedures that process and examine collected data to identify patterns, trends, or specific features, including machine learning, statistical analysis, and pattern recognition methods.

The term “repetitive actions” refers to sequences or sets of operations that are performed repeatedly by a user within a certain time period or operational context.

The term “automation proposal” refers to a recommendation or plan generated by the system, suggesting which actions or processes may be automated to improve efficiency, reduce manual workload, or address user condition.

The term “output information” refers to electronic data generated by the system that is presented to a user or external device, including automation proposals, instructions, or status notifications.

The term “generative artificial intelligence model” refers to a computational model, such as a neural network, which is capable of producing automation proposals or solutions based on input data including user operation information and biometric information.

The term “user information terminal” refers to a user-operated electronic interface device, such as a smart device or terminal, that can receive, display, and transmit information between the user and the system.

The term “external device” refers to any machinery, robot, or apparatus that can be controlled by the system to execute automated processes or actions as instructed by the server.

The term “emotion estimation processing” refers to computational procedures that analyze user data to infer or evaluate the user's emotional or psychological state.

The term “encrypted communication” refers to the practice of encoding data transmissions between devices or components to protect the data from unauthorized access or interception.

The term “evaluation information” refers to feedback, ratings, or responses provided by the user concerning the effectiveness or suitability of automation proposals or system outputs.

The term “business automation processing” refers to the execution of tasks, workflows, or procedures by automated means, typically involving process control, documentation, or other operational functions within an organization.

In one embodiment of the present invention, a system is provided which performs automated business process optimization based on user operation information and biometric information.

The server comprises a processor capable of executing machine learning algorithms and hosting a generative artificial intelligence model. The terminal, such as a smart device or workstation, operates a client program that monitors and records user operation information, including but not limited to keystrokes, mouse movements, application activations, and system interactions. The terminal further gathers biometric information, such as indicators of emotional or physiological state, for example, stress level or satisfaction, inferred from typing speed, mouse activity, or gaze tracking data. As hardware, the system can utilize common computers, smart devices, servers equipped with suitable CPUs and/or GPUs (for example, x86 servers or GPU-accelerated servers), and work machinery or industrial robots controlled by programmable logic controllers (PLCs). As software, the server relies on programming languages and frameworks such as Python, machine learning libraries like TensorFlow or PyTorch, and a natural language generative AI model. The terminal operates with client programs written in languages appropriate for the device, such as Swift for iOS or Kotlin for Android.

The terminal encrypts collected user operation information and biometric information and transmits these data to the server via a secure communication protocol such as HTTPS. The server receives and decrypts the transmitted data, then preprocesses the information by data cleaning and normalization procedures. Using data analysis techniques, including pattern mining algorithms available in libraries such as scikit-learn, the server identifies repetitive actions in the user's activities.

The server then utilizes the generative AI model to generate an automation proposal tailored to the detected repetitive actions and the user's biometric state. The construction and fine-tuning of the generative AI model is performed using both user operation information and biometric information as training data. Output information, including the automation proposal, is transmitted to the user information terminal, where the user is prompted to review, approve, or modify the proposal through an interactive interface.

Upon user approval, the server generates instructions or automation scripts compatible with the external device, such as the PLC of a work machine, and transmits these for execution. During automated processing, the system monitors changes in the user’s biometric information. If undesirable or risky biometric changes are detected, for example an excessive rise in the user’s stress level, the processor may adjust or suspend automation processing as necessary for user wellbeing.

Furthermore, the server continuously improves the generative AI model by updating it based on evaluation information or feedback and recent biometric data provided by the user after execution of automation, employing retraining techniques available in modern machine learning frameworks.

As a specific example, consider the use of this system in a factory where a user repeatedly configures and operates a robot arm for part assembly tasks. The terminal records operation sequences and stress indicators, encrypts these data, and sends them to the server. The server identifies the most frequent operation patterns and, using the generative AI model, creates an automation proposal that suggests grouping several steps into a single automated sequence and recommending periodic breaks if high stress is detected.

A sample prompt sentence for the generative AI model in this case may be:

"Analyze the operation logs from a manufacturing workstation and the operator’s associated stress data. Identify repetitive task patterns and suggest automation solutions that reduce manual workload and operator stress."

In this way, the present invention enables effective and secure implementation of automation proposals, adaptive to user state, in various industrial or business environments.

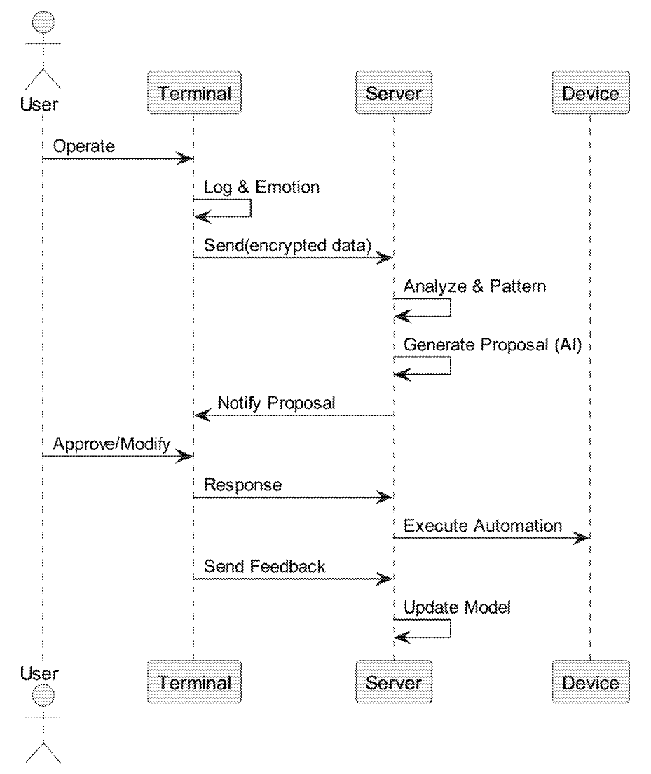

The following describes the processing flow using FIG. 12.

### Step 1:

The terminal executes a background monitoring program to collect user operation information and biometric information. The input for this step is the real-time user activity on an information processing device, such as keyboard inputs, mouse actions, and application usage, along with data streams indicating physiological markers like typing speed and mouse movement variability. The terminal processes these inputs by recording each event with a timestamp and by applying algorithms to estimate emotional state, such as stress level, from the collected biometric signs. The output is a set of time-stamped operation log entries and associated biometric state records.

### Step 2:

The terminal encrypts the collected operation information and biometric data, and initiates secure transmission to the server. The input is the log file or dataset created in Step 1. The terminal performs data packaging, applies encryption (such as AES encryption), and establishes a secure connection (for example, HTTPS) to the server endpoint. The output is an encrypted data packet sent to the server.

### Step 3:

The server receives the encrypted data from the terminal, decrypts it, and performs preprocessing of the information. The input is the encrypted data packet transmitted from the terminal. The server performs decryption, checks data integrity, cleans up incomplete or flawed entries, normalizes timestamp formats, and aligns the operation data with biometric records. The output is a processed and structured dataset, ready for analysis.

### Step 4:

The server analyzes the processed data to detect repetitive actions using data analysis techniques such as frequent pattern mining or sequential pattern mining. The input is the structured dataset from Step 3. The server applies pattern recognition algorithms and machine learning models using software frameworks like TensorFlow or scikit-learn to discover sequences of user operations that occur frequently. The output is a list of identified repetitive action patterns, together with aggregated biometric data for each pattern.

### Step 5:

The server generates an automation proposal based on the detected repetitive actions and biometric states using a generative AI model. The input for this step is the list of repetitive action patterns and corresponding biometric summaries from Step 4. The server constructs a natural language prompt and sends it, along with relevant data, to the generative AI model, which returns a tailored automation proposal (for example, merging frequently repeated steps into a macro, or adding break suggestions if stress is high). The output is a structured proposal containing automation instructions and recommendations.

### Step 6:

The server sends the automation proposal to the terminal for user review. The input is the structured proposal from Step 5. The server creates and transmits a notification or user interface message containing the proposal, which the terminal receives and displays to the user. The output is the presentation of the automation proposal on the user information terminal.

### Step 7:

The user reviews the automation proposal on the terminal, determines whether it is acceptable, and either approves, modifies, or rejects it. The input is the proposal as displayed on the terminal interface. The user interacts with the terminal to indicate approval or provide modifications, for example by selecting options, editing steps, or submitting feedback. The output is the user's approval, modification, or rejection data.

### Step 8:

The server receives the user’s approval or modifications, then generates and transmits automation commands or scripts to the external device for execution. The input is the user’s approval or modification data. Based on this, the server translates the approved proposal into executable commands or control scripts suitable for the external device, such as work machine or industrial robot, and dispatches the instructions. The output is the execution of automated tasks by the external device.

### Step 9:

The terminal monitors the user’s biometric information during execution of the automated process and sends updates or alerts to the server as needed. The input is real-time biometric information collected during automation by the terminal. The terminal analyzes this data to detect any significant changes (such as increased stress), and provides immediate feedback to the server. The output is a stream of biometric updates and incident alerts, if any.

### Step 10:

The server collects post-execution feedback and biometric information, and updates the generative AI model to improve future automation proposals. The input is the updated biometric data and user evaluation or feedback received from the terminal after automation execution. The server processes these data by updating the training set for the generative AI model and performing retraining as needed. The output is an improved AI model capable of generating more relevant and effective automation proposals for subsequent operations.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In the conventional use of information processing systems, users are frequently burdened by the need to perform repetitive and inefficient operations, which are not automatically optimized for their individual working habits or emotional states. As a result, users may experience increased stress and reduced operational efficiency. Moreover, there is a lack of scalable and secure means to collect, analyze, and utilize both activity and emotional data for dynamically generating and executing workflow automation proposals tailored to each user. Additionally, conventional systems are insufficient in ensuring data privacy and security when handling sensitive user behavior and emotion data.

The specific processing by the specific processing unit 290 of the data processing device 12 in Example 2 is realized by the following means.

The present invention provides a server comprising a processor configured to acquire and record real-time activity information and emotional state data from a user’s information processing apparatus, analyze said data to identify repetitive workflow steps, generate automation proposals using a generative model and prompt sentence considering both the workflows and emotional state, present proposals to the user for approval or correction, execute the approved workflow automation, collect feedback and execution data, adaptively optimize the generative model, and perform encryption for secure data transmission and storage. This enables reduction of user workload and stress through individualized workflow automation, while ensuring data confidentiality and supporting continuous optimization based on user feedback and emotional state.

The term “activity information” refers to data representing a user’s operations, input behaviors, and gaze movements while interacting with an information processing apparatus.

The term “emotional state data” refers to information indicating the psychological or affective condition of a user, such as stress level or satisfaction, inferred from behavioral patterns and physiological signals during use of an information processing apparatus.

The term “information processing apparatus” refers to an electronic device capable of executing software programs and processing digital data, including but not limited to computers, tablets, and smart devices.

The term “generative model” refers to a machine learning or artificial intelligence algorithm that can generate new outputs, such as automation proposals, based on trained data, user history, and prompt sentences.

The term “prompt sentence” refers to a natural language input or instruction provided to a generative model in order to guide the generation of automation proposals or responses.

The term “automation proposal” refers to a recommended workflow or sequence of actions automatically generated to streamline repetitive user operations and reduce workload, considering the user’s activity and emotional state data.

The term “workflow schedule” refers to an arrangement or timetable that determines when automation proposals are to be executed by the system.

The term “user feedback” refers to information provided by the user, including approval, corrections, and responses regarding the automation proposals and system operations.

The term “encryption” refers to a process of transforming data using cryptographic algorithms to protect the confidentiality and integrity of activity information and emotional state data during storage and communication over networks.

The term “data confidentiality” refers to the protection of activity information and emotional state data from unauthorized access or disclosure at all stages, including acquisition, transmission, and storage.

One embodiment for implementing the present invention is described as follows.

The server and the terminal cooperate to collect, process, analyze, and utilize user activity and emotional state data in order to dynamically generate, present, and execute workflow automation proposals tailored to each user.

The terminal can be a general-purpose information processing apparatus such as a personal computer, tablet, or smart device, equipped with input devices including a keyboard, mouse, and optionally, a gaze tracking sensor (such as an eye tracker). The terminal has a client program installed, which is developed with programming languages such as Python, Java, or JavaScript, and uses system-level APIs (for example, Windows API, macOS Accessibility API, or Android Input API) to monitor user input and application interactions. If gaze tracking is included, publicly available hardware such as a generic eye tracker can be used in combination with its corresponding SDK.

The terminal continuously collects activity information, including operation data (e.g., keyboard and mouse input, application launches) and, where present, gaze data. The terminal is also equipped with an emotion estimation engine, which may be implemented as a local software module using an open-source or commercial emotion recognition library, such as Affectiva SDK, OpenFace, or a proprietary model. The emotion engine receives behavioral data as input and uses machine learning techniques to estimate the user's emotional state, generating emotional state data such as stress or satisfaction levels.

All collected activity information and emotional state data are encrypted on the terminal using a cryptographic algorithm, such as Advanced Encryption Standard (AES). Encryption is performed using widely available libraries like OpenSSL, and the resulting encrypted data are transmitted at predetermined intervals to the server. Data transmission is handled via secure network protocols such as HTTPS or TLS.

The server, which can be any standard server device running a general-purpose operating system (such as Linux or Windows Server), is equipped with a processor capable of decrypting received data using AES decryption. The server stores the decrypted activity information and emotional state data and performs pattern recognition and workflow analysis, using frameworks or libraries such as pandas, scikit-learn, or Apache Spark. The server identifies repetitive operational patterns by applying data mining algorithms, including but not limited to PrefixSpan and Apriori.

Once repetitive workflows are detected, the server uses a generative AI model, such as a large language model or generative pre-trained transformer running on the server, to generate personalized automation proposals. These proposals are created by supplying prompt sentences to the generative AI model, which take into account both the detected workflow patterns and the emotional state data to optimize user workload and well-being. Example prompt sentences that can be used for the generative AI model are as follows:

"Analyze the provided activity logs and emotional state data. Generate an automation proposal that reduces workload and stress for the user."

"If a user repeatedly processes files under high stress, suggest a workflow automation plan to improve efficiency and reduce stress."

The server then transmits the generated automation proposal to the terminal. The user reviews the proposal via a user interface on the terminal, which may be a web-based dashboard or a native application interface, and is given the option to approve, reject, or modify the proposal according to their preferences.

If the user approves the proposal, the terminal schedules and executes the automation according to the proposal and workflow schedule, using native automation tools provided by the operating system (such as Task Scheduler on Windows, cron on Linux, or launchd on macOS) or a dedicated workflow automation engine. During and after execution, the terminal continues to collect execution results, activity information, and emotional state data, and this information is sent back to the server through the same secured and encrypted communication method.

The server uses feedback and additional collected data to continually retrain and optimize the generative AI model, such that future proposals are increasingly adapted to the individual user’s work style and emotional tendencies. Throughout the process, strong encryption safeguards the confidentiality of all activity information and emotional state data on both the terminal and server, as well as during network transmission.

This embodiment enables any user with a compatible information processing apparatus to obtain tailored automation proposals dynamically generated based on both their activities and emotional states, thereby reducing repetitive workload, minimizing stress, and facilitating improved operational efficiency in a secure and scalable manner.

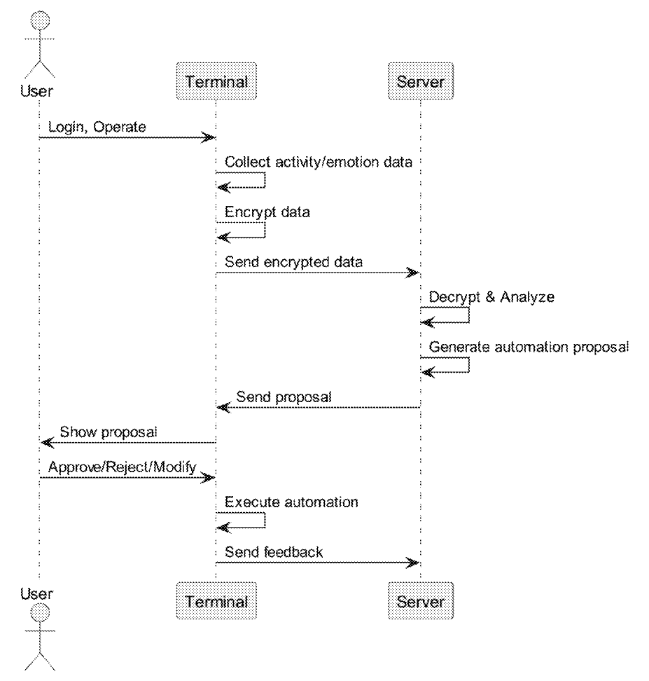

The following describes the processing flow using FIG. 13.

### Step 1:

The terminal initializes a monitoring program when the user logs in. The terminal collects user operation data, such as keystrokes, mouse clicks, application launches, and gaze tracking data if available. The input for this step consists of system events from the operating system and sensor data from input devices. The terminal processes the input by extracting timestamped event records and storing them as structured activity logs. The output is a continuously updated activity log file.

### Step 2:

The terminal activates an emotion estimation engine that receives the recorded activity log as input. The engine analyzes patterns in the activity log, such as speed of input, erratic behavior, and gaze focus, by applying a machine learning model or emotion detection algorithms (for example, using Affectiva SDK or OpenFace). The terminal transforms the behavioral data into estimated emotional state metrics, such as stress or satisfaction scores. The output of this step is emotional state data corresponding to each time segment in the activity log.

### Step 3:

The terminal encrypts the generated activity log and emotional state data using an encryption algorithm such as AES, with the input being the raw log files and emotion data. By applying the AES encryption process (using a library like OpenSSL), the terminal produces encrypted binary files. The output is an encrypted data package ready for secure transmission.

### Step 4:

The terminal sends the encrypted data package to the server over a secure network connection. The input is the encrypted data file, and the process uses HTTPS or TLS for communication. The terminal initiates a file transfer protocol and sends the data as a payload in a POST request. The output is the confirmation of successful data upload to the server.

### Step 5:

The server receives the encrypted data package from the terminal. The server uses its own secret key to decrypt the received data, with the encrypted package as input. By applying decryption algorithms (such as AES through OpenSSL), the server restores the original activity log and emotional state data. The output is the plaintext data set containing user behavior and emotion records.

### Step 6:

The server analyzes the activity log and emotional state data. The input comprises the decrypted activity and emotion data. The server uses data mining and pattern recognition algorithms (e.g., PrefixSpan, Apriori) to identify repetitive sequences and correlate them with emotional states. The output is a list of detected repetitive workflows and associated emotion metrics.

### Step 7:

The server generates an automation proposal for the user by feeding detected patterns and emotional metrics into a generative AI model (such as a large language model). The input is the list of repetitive workflows and emotion data, along with a prompt sentence: “Based on the user’s activity and stress patterns, generate an automation proposal to reduce workload and stress.” The AI model processes the prompt and user information to produce a text-based automation suggestion. The output is a personalized automation proposal document.

### Step 8:

The user receives the automation proposal via the terminal’s user interface. The user reviews the proposal and provides feedback, either approving, rejecting, or editing the proposed workflow steps. The input is the automation proposal text and interactive interface controls. The terminal processes the user’s input and produces a finalized automation instruction.

### Step 9:

The terminal implements the approved automation using built-in scheduling tools, such as Task Scheduler, cron, or launchd. The input is the finalized automation instruction and a schedule. The terminal executes scripts or commands according to the workflow definition and continues collecting feedback about activity and emotional state during execution. The output is the automated task result, along with updated activity and emotion data.

### Step 10:

The server receives new feedback, including activity and emotional data collected during automated execution. The input is the post-execution logs, emotion scores, and feedback. The server updates the generative AI model and its automation generation strategy by retraining or fine-tuning on the new data. The output is an optimized generative model and improved automation proposals for future cycles.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In a conventional work environment, it is difficult to accurately and promptly grasp the emotional state of users and to identify and automate repeated operations or tasks performed by users. Thus, it is challenging to propose optimal work environment adjustments and efficient workflow automation tailored to the user's psychological condition and operational behavior. As a result, unnecessary workload may accumulate, productivity may decrease, and users may experience stress or fatigue that is not adequately detected or addressed.

The specific processing by the specific processing unit 290 of the data processing device 12 in Application Example 2 is realized by the following means.

The present invention provides a server comprising a processor configured to collect time-series operation data from an information processing device used by a user, analyze operation patterns to identify repetitive tasks, utilize a generative artificial intelligence model by inputting the identified tasks and prompt sentences to generate workflow automation proposals, analyze psychological states based on motion and acoustic information, create proposals to optimize the work environment and work pace, present these proposals to the user, and execute approved procedures or adjustments. This enables automatic detection of repetitive tasks and emotional states, data-driven generation of automation and environmental adjustment proposals, real-time user feedback processing, and continuous improvement of proposal accuracy - thereby reducing unnecessary workload and enhancing overall productivity and user well-being.

The term “operation event” refers to an individual interaction or action performed by a user on an information processing device, including but not limited to keyboard input, mouse movement, or click action, which is collected as data with a timestamp.

The term “information processing device” refers to an electronic apparatus operated by a user for business or personal tasks, such as a computer, tablet, or workstation, capable of running applications and recording input activities.

The term “time-series data” refers to a sequence of data points collected at consecutive and typically evenly spaced time intervals, representing the chronological order of events or actions.

The term “operation pattern” refers to a sequence or combination of operation events that may repeat over time, indicating a regular task or workflow performed by the user.

The term “repetitive task” refers to a set of actions or procedures regularly performed in a similar manner by a user, suitable for identification and automation.

The term “generative artificial intelligence model” refers to a computational model, typically based on a neural network, capable of producing new information, such as workflow automation proposals, in response to prompts and input data.

The term “prompt sentence” refers to a textual instruction or query provided to a generative artificial intelligence model in order to guide the generation of a desired output or proposal.

The term “motion information” refers to data captured from sensors or devices reflecting the physical movements of a user, such as hand motion or body posture.

The term “acoustic information” refers to audio data representing sounds made by the user, including speech patterns, tone, and other vocal characteristics.

The term “psychological state” refers to a mental or emotional condition of the user, inferred from motion information and acoustic information, representing metrics such as stress, fatigue, or concentration.

The term “work environment adjustment proposal” refers to a recommendation or suggestion generated to modify settings, workflow, or conditions of the user’s working environment to improve comfort, health, or productivity.

The term “workflow automation proposal” refers to a suggestion or instruction generated for automating one or more repetitive tasks performed by the user.

The term “user interface” refers to the means by which information and proposals are presented to the user and through which the user may provide inputs, including displays, input fields, and feedback mechanisms.

The term “feedback information” refers to responses or corrections provided by the user regarding the proposals or actions performed by the system, used to refine future system behavior or model accuracy.

The term “encryption” refers to the process of converting data, such as operation events, motion information, and acoustic information, into a secure format during communication to prevent unauthorized access and ensure confidentiality.

The terminal is configured to collect operation event data, including keyboard inputs, mouse operations, and the related timestamps, as the user performs their daily work. This operation data is stored locally in a structured database, such as SQLite, and may be transmitted securely to the server using encrypted communication protocols.

The terminal can be further equipped with input devices for capturing motion information (for example, a camera) and acoustic information (for example, a microphone). Software such as OpenCV may be utilized for image and video processing, while audio analysis can be achieved by libraries such as LibROSA. The terminal can process video and audio data locally to extract features related to the user's movement and speech, and can estimate the user's psychological state using a machine learning model, such as a model implemented with TensorFlow.

The server includes a processor that receives operation data and sensor data (motion information and acoustic information) from the terminals. The server stores this data and analyzes operation event records using analytical software and data processing frameworks, such as pandas and scikit-learn, to identify repetitive operation patterns. When repetitive tasks are detected, the server constructs a prompt sentence and provides the detected patterns and prompt to a generative artificial intelligence model. The server may employ a model based on general neural network architectures, running on a cloud-based platform, such as a neural network service or a general-purpose computation cluster.

For the generative artificial intelligence model, the server may utilize machine learning frameworks such as TensorFlow, and for deployment and training, cloud apparatus can be used. The model receives prompt sentences and operation data, and produces workflow automation proposals. For example, if a user repetitively enters data from one application to another, the system may suggest automating the transfer using an RPA (Robotic Process Automation) script.

The prompt sentence to the generative AI model may be formulated as:

"Analyze the following list of repetitive user actions and recommend automation strategies to improve productivity."

or

"Given the user's series of operation logs and corresponding audio data, judge the current level of stress and recommend both workflow automation and optimal break times to maximize the user's productivity."

The server also receives and analyzes the user's psychological state data, and based on this and the operation event data, creates proposals for adjusting the work environment, such as modifying work pace, recommending breaks, or providing ergonomic suggestions. These proposals, along with the workflow automation suggestions, are transmitted to the terminal and presented to the user via the user interface.

The user can approve, modify, or reject the proposals. Upon approval, the terminal automatically executes the recommended procedures, such as running a predefined script for workflow automation or displaying a break notification. All user feedback and task execution results are transmitted back to the server. The server aggregates this feedback and uses it for continuous retraining and refinement of the generative artificial intelligence model to enhance its proposal accuracy.

As a concrete example, if the terminal detects that the user repeatedly performs copy-and-paste operations between two software applications and the motion and audio data indicate elevated fatigue, the server may propose to automate the copy-and-paste process using a script and recommend a short break. The user interface on the terminal displays these proposals, and the user may choose to accept both. Upon acceptance, the terminal executes the script and triggers a reminder for break time.

Through these means, the system enables seamless collection, analysis, and feedback of user operations and psychological states; provides automated and adaptive workflow or environment proposals; and continuously improves system intelligence based on ongoing user feedback and data.

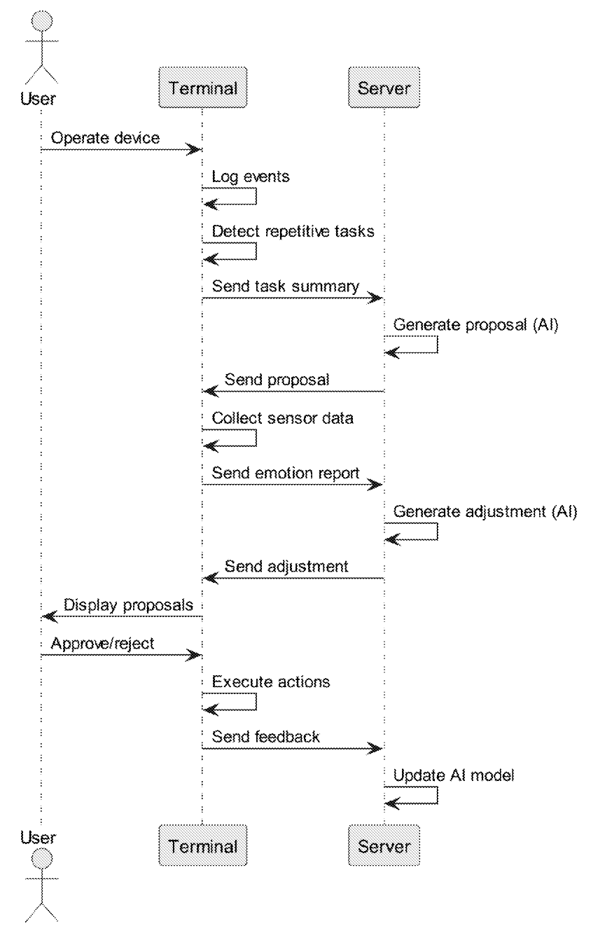

The following describes the processing flow using FIG. 14.

### Step 1:

The terminal collects operation event data from the user’s interactions, such as keyboard inputs and mouse movements, and records each operation with a timestamp and application context. As input, the terminal receives raw event signals from operating system hooks or input device drivers. The terminal then processes these raw signals into structured records and stores them in a local database or log file as output. This processed log includes the type of event, trigger time, and active application.

### Step 2:

The terminal detects repetitive operation patterns by analyzing the recorded operation event data. The input for this step is the structured event log created in Step 1. The terminal applies statistical analysis and pattern recognition algorithms to identify sequences of operations that occur with high frequency. Output from this step is a list of identified repetitive tasks, such as "copying values from one window to another 20 times per hour," which is stored as a summary report.

### Step 3:

The terminal transmits the summary report of repetitive tasks to the server via a secure communication protocol. The input is the repetitive task report, and the output is the successful delivery of this report to the server, typically as a JSON payload submitted over an encrypted connection.

### Step 4:

The server receives the repetitive task report from the terminal. The input for this step is the report itself. The server constructs a prompt sentence incorporating the repetitive task details and feeds both the task information and the prompt into a generative AI model. The server processes the received data using a neural network to generate automation proposals. The output is a set of recommended workflow automation actions, such as "Use a script to automate this copy-paste operation," which is prepared for sending back to the terminal.

### Step 5:

The terminal collects motion information via the camera and acoustic information via the microphone while monitoring the user. The inputs are video and audio signals from the respective sensors. The terminal processes these signals using computer vision and speech analysis software to extract movement speed and voice stress indicators. Next, the terminal inputs these features into a local or remote machine learning model, which outputs a predicted psychological state, such as "high stress" or "low fatigue." The output is an emotion report sent to the server.

### Step 6:

The server receives both the emotion report and repeated operation log from the terminal. Using these as inputs, the server aggregates the data and performs further analysis to determine whether the user’s work environment or task pace should be adjusted. The server constructs a second prompt sentence, such as "Given the user's stress level, recommend an optimal break schedule," and uses the generative AI model to create adjustment proposals. The output is a set of environment and productivity recommendations to be presented to the user.

### Step 7:

The terminal receives the automation and adjustment proposals from the server. The inputs are the proposals themselves. The terminal displays these suggestions to the user in the user interface, allowing the user to review, approve, modify, or reject each one. The output from this step is the user's decision, which is submitted back to the terminal for execution and also logged for system records.

### Step 8:

The terminal, based on user approval, executes the accepted workflow automation tasks (such as launching a script for automating a repetitive sequence) or triggers environment adjustments (such as displaying a break reminder). The input is the user's approval or modified proposal. The output is a log of executed actions, as well as feedback data, which is sent to the server.

### Step 9:

The server collects user feedback and execution logs received from the terminal as input. The server then uses this input to retrain and refine the generative AI model, incorporating user responses and execution results. The output from this stage is an updated model that enhances the future accuracy and relevancy of workflow automation and environment recommendations.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

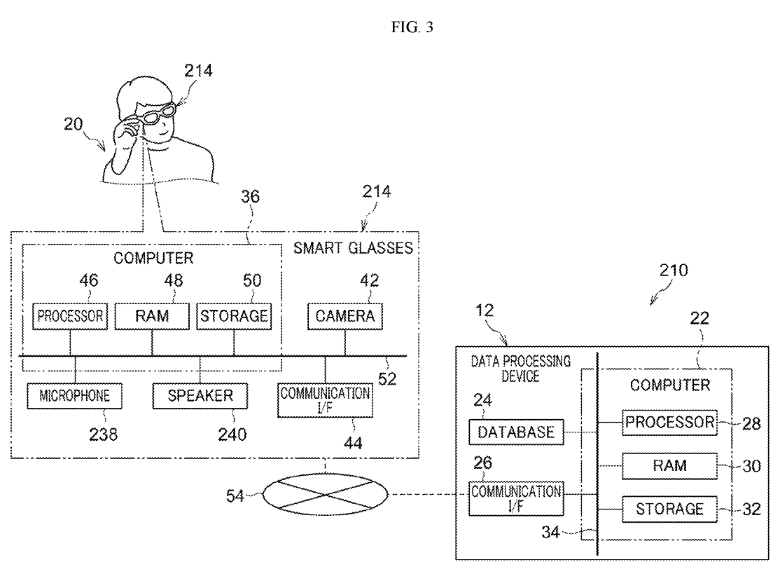

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

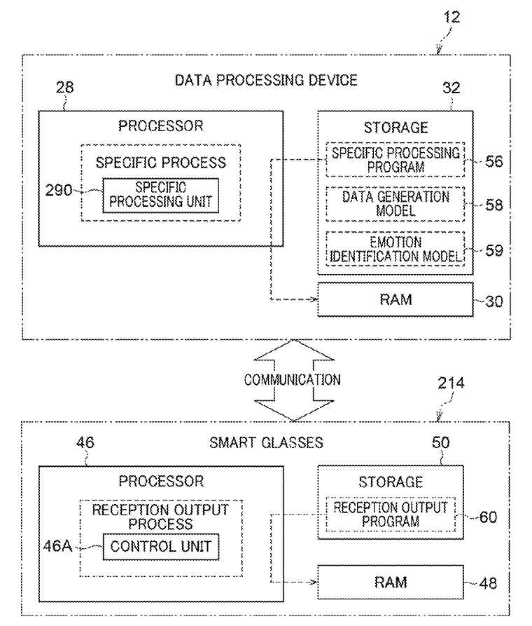

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

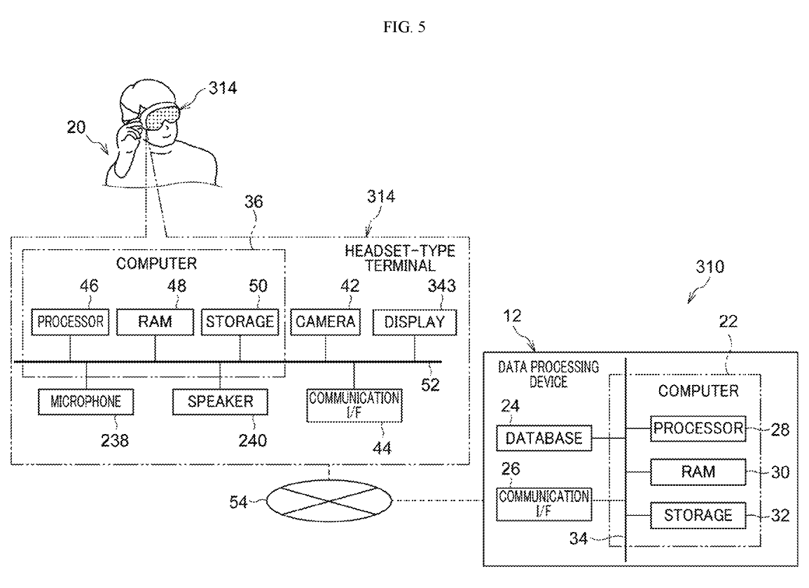

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

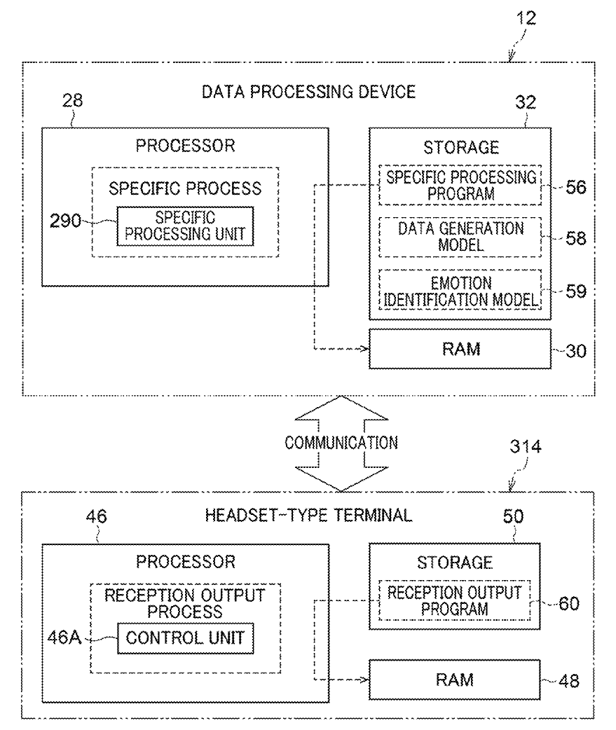

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

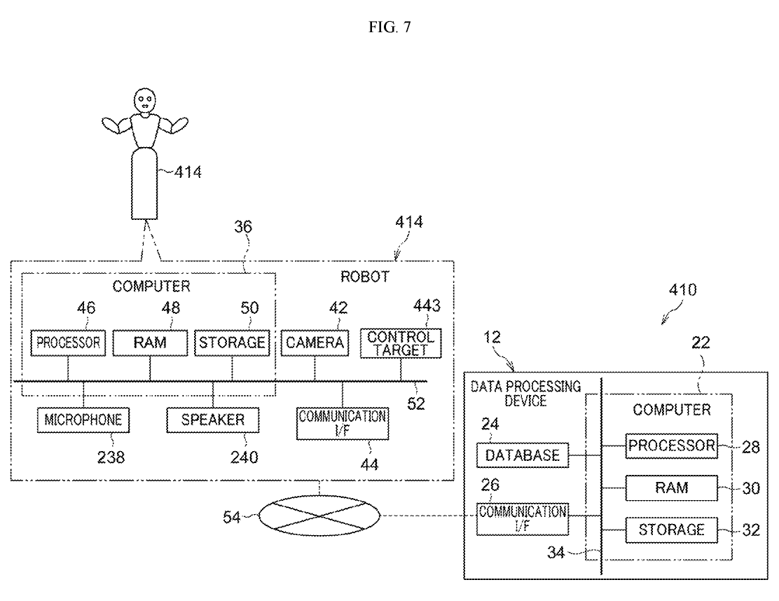

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

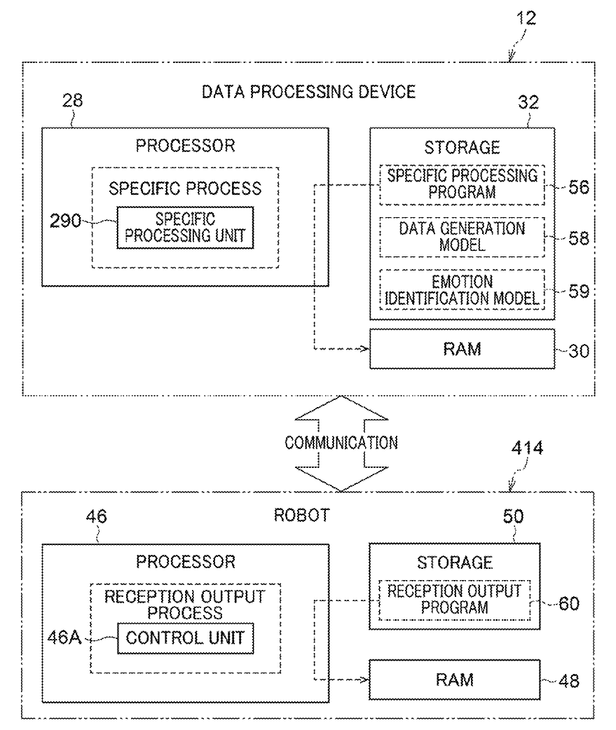

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

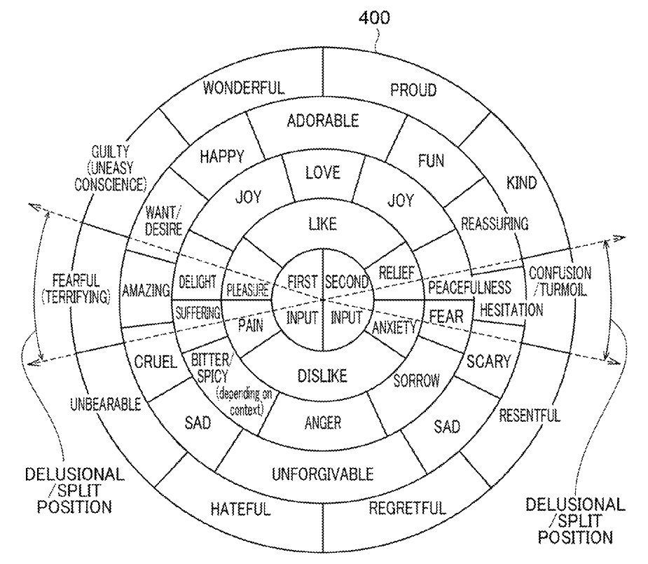

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o’clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don’t want to feel this way ever again” and “I don’t want to be chided again” is experienced in a robot. Another is a positive emotion in the area of “desire” on the reaction side. In other words, there are times when a positive feeling such as “desire more” and “want to know more” is experienced.

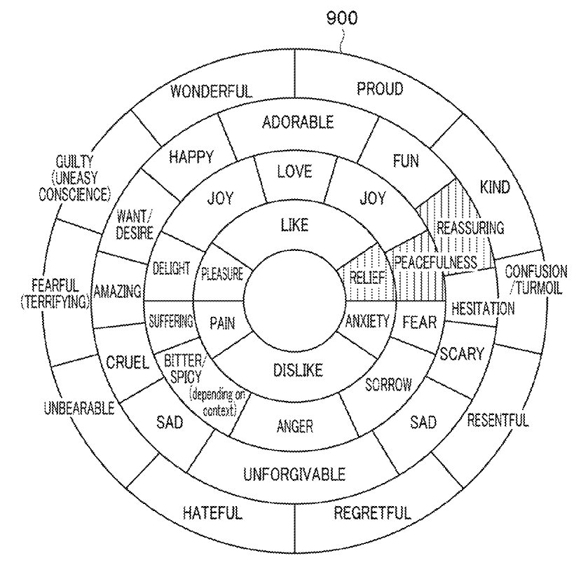

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,

wherein the processor is configured to

acquire operation history information of a user from an information processing device,

encrypt the acquired operation history information and transmit the encrypted information to a data processing device via a communication path,

decrypt, at the data processing device, the received encrypted operation history information and analyze the operation history information using machine learning and pattern recognition techniques to identify repetitive operation patterns,

generate, based on the identified repetitive operation patterns, an automation proposal by outputting a prompt sentence reflecting task content to a generative artificial intelligence model and receiving automation proposal information generated by the generative artificial intelligence model,

present the automation proposal information to a display device of the user and receive approval or modification input from the user, and

execute, on the information processing device, the automation process approved by the user.

### Supplementary 2

The system according to supplementary 1,

wherein the processor is configured to

retrain the generative artificial intelligence model and improve its accuracy based on feedback information from the user and the information processing device.

### Supplementary 3

The system according to supplementary 1,

wherein the processor is configured to

encrypt the acquired operation history information and transmit the encrypted information using a secure communication path.

### Application Example 1

### Supplementary 1

A system comprising a processor,

wherein the processor is configured to

collect a sequence of user operation information and biometric information from an information processing device,

analyze the collected user operation information and biometric information by data analysis techniques to extract repetitive actions,

generate output information including an automation proposal based on the extracted repetitive actions and biometric state,

construct a generative artificial intelligence model using the user operation information and biometric information as training data,

present the output information to a user information terminal, accept an approval or modification from a user, and instruct an external device to perform business automation processing according to the approved proposal,

perform emotion estimation processing and dynamically adjust the output information based on the user state,

and execute encrypted communication of information as a security measure.

### Supplementary 2

The system according to supplementary 1,

wherein the processor is configured to

update the generative artificial intelligence model based on evaluation information or biometric information from the user to improve the accuracy of automation proposals.

### Supplementary 3

The system according to supplementary 1,

wherein the processor is configured to

detect changes in the biometric information of a user during the execution of business automation processing and adjust or stop the automation processing when necessary.

### Example 2

### Supplementary 1

A system comprising a processor,

wherein the processor is configured to

acquire and record, in real time, activity information such as operation data, input behavior data, and gaze data, as well as emotional state data of a user from an information processing apparatus,

analyze the recorded activity information and emotional state data to identify repetitive workflow steps by utilizing both activity history and emotional state analysis,

generate an automation proposal by using a generative model and prompt sentence, the automation proposal being based on the identified repetitive workflow steps and emotional state data, and configured to reduce user workload as well as take into consideration the emotional state of the user,

present the automation proposal to the user and receive input for approval or correction from the user,

execute an approved automation proposal according to a workflow schedule, and further collect execution results and execution-time activity and emotional information,

continually train and optimize the generative model based on the collected information, workflow conditions, and user feedback,

and encrypt the acquired activity information and emotional data to enhance data confidentiality.

### Supplementary 2

The system according to supplementary 1,

wherein the processor is configured to adaptively update the generative model and automation proposal generation procedure based on input information, approval information, and emotional state data received from the user.

### Supplementary 3

The system according to supplementary 1,

wherein the processor is configured to perform encryption of activity information and emotional state data during data transfer over a communication network, and to perform decryption upon reception.

### Application Example 2

### Supplementary 1

A system comprising a processor,

wherein the processor is configured to

collect operation events performed on an information processing device of a user as time-series data;

analyze the time-series data of the operation events to extract operation patterns and identify repetitive tasks;

generate proposals for workflow automation by inputting the identified repetitive tasks and a prompt sentence to a generative artificial intelligence model based on a general neural network;

analyze motion information and acoustic information obtained from an emotion detection input device to evaluate a psychological state of the user;

create proposals for work environment adjustment or optimization of work pace based on the psychological state and the operation events;

present the automation proposal or adjustment proposal to the user via a user interface and receive approval or modification input from the user;

and perform actions according to the approved automation procedures or environmental adjustment proposals.

### Supplementary 2

The system according to supplementary 1,

wherein the processor is configured to retrain the generative artificial intelligence model based on feedback information from the user to improve proposal accuracy.

### Supplementary 3

The system according to supplementary 1,

wherein the processor is configured to perform encryption of the operation event data, motion information, and acoustic information during communication to ensure information security.

What is claimed is:

1. A system comprising a processor,
wherein the processor is configured to collect a sequence of operations performed on a user computer device,
analyze the collected operation data and identify repetitive operations,
generate automation proposals for the identified repetitive tasks,
train and construct a domain-specific generation model using the operation data,
present the automation proposals to the user and execute the automation upon user approval.

2. The system according to claim 1, wherein the processor is further configured to update the generation model based on user feedback.

3. The system according to claim 1, wherein the processor is further configured to transmit the operation data in an encrypted manner in consideration of security.
